(19) United States
(12) Patent Application Publication
(10) Pub. No.: US 2012/0300387 A1
(43) Pub. Date: Nov. 29, 2012

(54) DISK DRIVE ASSEMBLY

(75) Inventor: YUN-LUNG CHEN, Tu-Cheng (TW)

(73) Assignee: HON HAI PRECISION INDUSTRY CO., LTD., Tu-Cheng (TW)

(21) Appl. No.: 13/325,263

(22) Filed: Dec. 14, 2011

(30) Foreign Application Priority Data
May 26, 2011 (CN) 201110138706.0

(51) Int. Cl. G06F 1/16

(52) U.S. Cl. 361/679.33

(57) ABSTRACT

A disk drive assembly includes a disk drive and a drive bracket. The disk drive includes a first sidewall. The first sidewall includes a sidewall body, a resilient tab and a mounting protrusion extending from the sidewall body. The drive bracket includes a first side panel substantially parallel to the sidewall body. The first side panel defines a securing opening and a cutout formed by recessing an edge of the first side panel. The disk drive is received in the drive bracket along a first direction to enable the mounting protrusion to move into the cutout, thereby preventing the disk drive from moving along the first direction. The disk drive in received in the drive bracket along the first direction to enable the resilient tab to be engaged in the securing opening, thereby preventing the disk drive from moving along a second direction opposite to the first direction.

### CROSS-REFERENCE TO RELATED APPLICATIONS

This application is related to co-pending U.S. patent application, entitled “DISK DRIVE ASSEMBLY,” Attorney Docket No. US39081, U.S. application Ser. No. 13/296,537, filed on Nov. 15, 2011, and co-pending U.S. patent application, entitled “DISK DRIVE ASSEMBLY,” Attorney Docket No. US39177.

### BACKGROUND

1. Technical Field

The disclosure generally relates to a disk drive assembly.

2. Description of Related Art

Disk drives, such as a hard disk drive or a compact disc read-only memory drive, usually require brackets on a front plate of a computer enclosure to receive the drives. A large space is needed in the computer enclosure to install the disk drives. However, in some thin computer enclosures, the drives cannot be installed after a motherboard has been installed in the computer enclosure.

Thus, there is room for improvement within the art.

### BRIEF DESCRIPTION OF THE DRAWINGS

FIG. 1 is an exploded, isometric view of an embodiment of a disk drive assembly.

FIG. 2 is similar to FIG. 1, but viewed from another aspect.

FIG. 3 is an assembled view of the disk drive assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

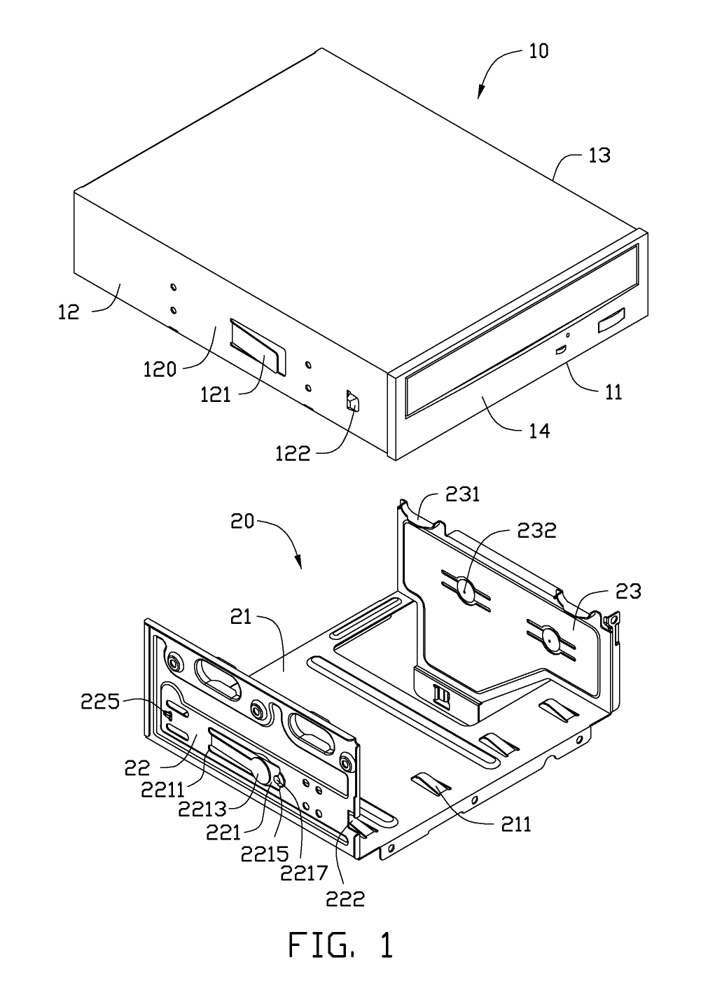

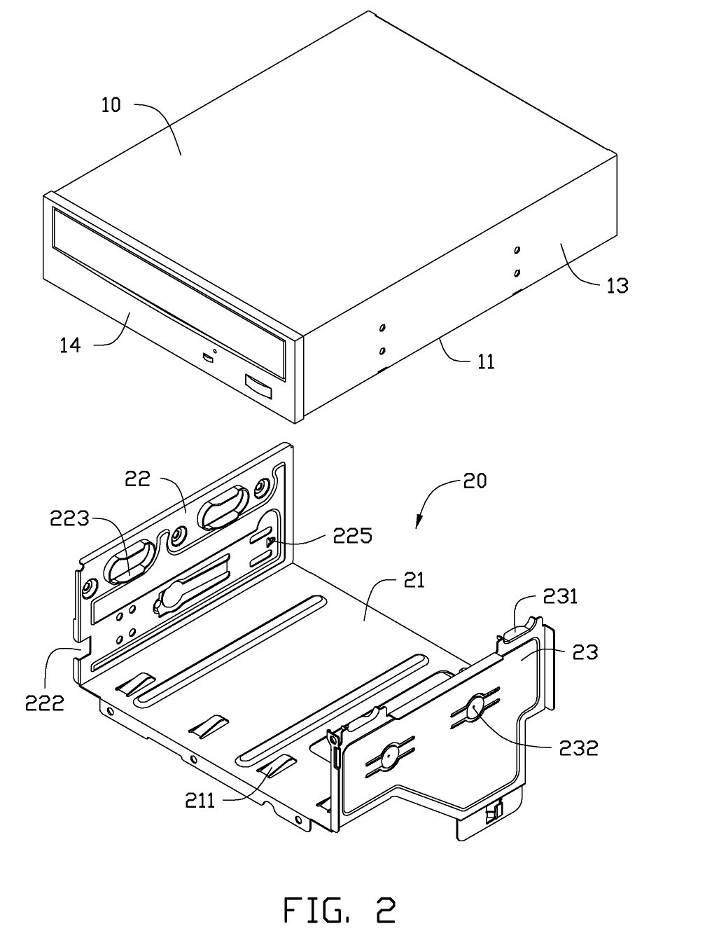

Referring to FIGS. 1 and 2, one embodiment of a disk drive assembly in includes a disk drive 10 and a drive bracket 20.

The disk drive 10 includes a bottom wall 11, a first sidewall 12 extending substantially perpendicularly from the bottom wall 11, a second sidewall 13 extending substantially perpendicularly from the bottom wall 11, and a front wall 14 connected between the first sidewall 12 and the second sidewall 13. The first sidewall 12 includes a sidewall body 120, a resilient tab 121 extending slightly outwardly from the sidewall body 120, and a resisting protrusion 122 protruding from the sidewall body 120. A free end of the resilient tab 121 extends towards the mounting protrusion 122.

The drive bracket 20 includes a bottom panel 21, a first side panel 22 extending substantially perpendicularly from the bottom panel 21, and a second side panel 23 extending substantially perpendicularly from the bottom panel 21. The first side panel 22 is substantially parallel to the sidewall body 120.

A securing opening 221 is defined in the first side panel 22 corresponding to the resilient tab 121. A cutout 222 is defined in a front side of the first side panel 22 corresponding to the mounting protrusion 122. The cutout 222 can be formed by recessing an edge of the first side panel 22. The drive bracket 20 further includes a resisting portion 2213 extending from a first edge 2211 of the securing opening 221. The drive bracket 20 further includes a stopper protrusion 2217 extending from a second edge 2215 of the securing opening 221. The first edge 2211 is opposite to the second edge 2215. The first side panel 22 includes two first stopper portions 223. The drive bracket 20 further includes a resisting protrusion 225 protruding from the first side panel 22. The securing opening 221 is disposed between the cutout 222 and the resisting protrusion 225.

The bottom panel 21 includes a plurality of contacting tabs 211 for contacting the bottom wall 11. The drive bracket 20 further includes two stopper portions 231 extending from an upper edge of the second side panel 23. The drive bracket 20 further includes two resilient protrusions 232 extending from the first second side panel 23. Each resilient protrusion 232 is semi-spherical shaped.

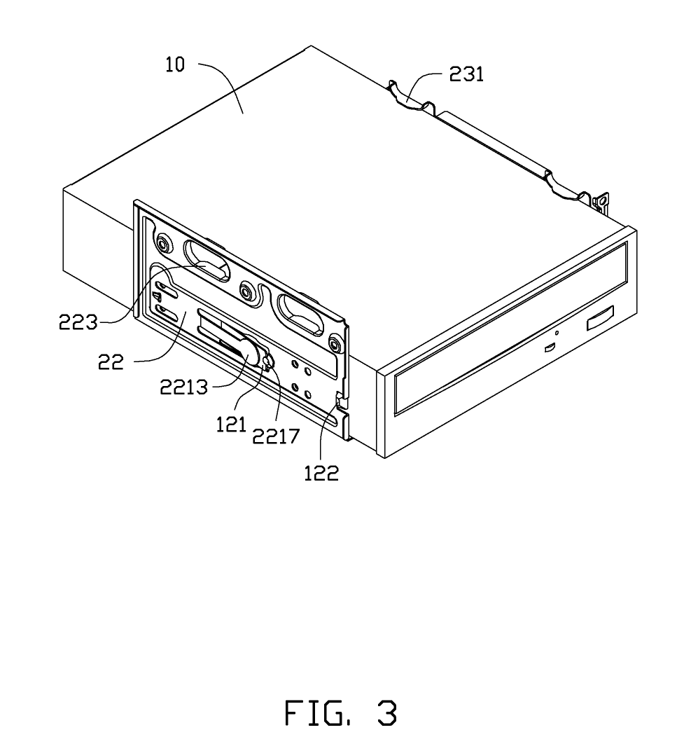

Referring to FIGS. 1 to 3, in assembly, the disk drive 10 is aligned with the drive bracket 20. The disk drive 10 is moved to the drive bracket 20 to enable the resilient tab 121 to resist an inner surface of the first side panel 22 of the drive bracket 20. The resilient tab 121 is deformed resiliently. The bottom wall 11 of the disk drive 10 contacts the contacting tabs 211 of the drive bracket 20. The disk drive 10 is disposed between the first stopper portions 223 and the bottom panel 21 and also between the second stopper portions 231 and the bottom panel 21. The disk drive 10 is pushed inside the drive bracket 20 to align the resilient tab 121 with the securing opening 221. The resilient tab 121 is released and engages in the securing opening 221, thereby preventing the disk drive from moving along a first direction substantially parallel to the first side panel 12. At this time, the mounting protrusion 122 is engaged in the cutout 222 to prevent from moving along a second direction substantially opposite to the first direction. The free end of the resilient tab 121 resists the stopper protrusion 2217 of the drive bracket 20.

In disassembly, the resisting portion 2213 is pressed to resist the resilient tab 121. The resilient tab 121 is deformed to move close to the sidewall body 120. The guiding portion 1213 is pressed to deform the first resilient tab 121 towards the sidewall body 120. The disk drive 10 is then pulled out of the drive bracket 20.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A disk drive assembly comprising:
a disk drive comprising a first sidewall, the first sidewall comprising a sidewall body, a resilient tab, and a mounting protrusion, the resilient tab and the mounting protrusion extending from the sidewall body; and
a drive bracket comprising a first side panel substantially parallel to the sidewall body, the first side panel defining a securing opening and a cutout formed by recessing an edge of the first side panel;
wherein the disk drive is adapted to be received in the drive bracket along a first direction to enable the mounting protrusion to move into the cutout, thereby preventing the disk drive from moving along the first direction, and to enable the resilient tab to engage in the securing opening, thereby preventing the disk drive from moving along a second direction opposite to the first direction.

2. The disk drive assembly of claim 1, wherein the drive bracket comprises a stopper protrusion extending an edge of the securing opening, and a free end of the resilient tab resists the stopper protrusion.

3. The disk drive assembly of claim 1, wherein the drive bracket comprises a resisting portion extending from an edge of the securing opening; the resisting portion is adapted to press the resilient tab to enable the resilient tab to disengage from the securing opening.

4. The disk drive assembly of claim 1, wherein the drive bracket comprises a bottom panel; the first side panel extends substantially perpendicularly from the bottom panel; and the disk drive is located on the bottom panel.

5. The disk drive assembly of claim 4, wherein the drive bracket comprises a first stopper portion extending from the first side panel, and the disk drive is located between the first stopper portion and the bottom panel.

6. The disk drive assembly of claim 5, wherein the bottom panel comprises a plurality of contacting tabs contacting the disk drive.

7. The disk drive assembly of claim 5, wherein the drive bracket further comprises a second side panel extending substantially perpendicularly from the bottom panel; the disk drive is located between the first side panel and the second side panel; the drive bracket comprises a second stopper portion extending from the second side panel; and the disk drive is located between the second stopper portion and the bottom panel.

8. The disk drive assembly of claim 4, wherein the drive bracket further comprises a second side panel extending substantially perpendicularly from the bottom panel; the disk drive comprises a second sidewall substantially parallel to the first sidewall; and the drive bracket comprises a resilient protrusion protruding from the second side panel, the resilient protrusion resiliently resisting the second sidewall.

9. The disk drive assembly of claim 1, wherein the drive bracket further comprises a resisting protrusion extending from the first side panel, the resisting protrusion resists the sidewall body, and the securing opening is located between the cutout and the resisting protrusion.

10. A disk drive assembly, comprising:
a disk drive comprising a first sidewall, the first sidewall comprising a sidewall body and a mounting protrusion extending from the sidewall body; and
a drive bracket comprising a bottom panel, a first side panel extending substantially perpendicularly from the bottom panel, and a second side panel extending substantially perpendicularly from the bottom panel, wherein the first side panel is substantially parallel to the sidewall body; the disk drive is located on the bottom panel; the first side panel defines a cutout formed by recessing an edge of the first side panel; the mounting protrusion is adapted to move into the cutout along a first direction substantially parallel to the bottom panel; the drive bracket further comprises a first stopper portion extending from the first side panel; the disk drive is located between the first stopper portion and the bottom panel to prevent from moving in a second direction substantially perpendicular to the bottom panel.

11. The disk drive assembly of claim 10, wherein the first side panel defines a securing opening and the disk drive comprises a resilient tab extending slightly outward from the sidewall body along a second direction substantially opposite to the first direction; the securing opening engages with the resilient tab to prevent the disk drive from moving along the second direction.

12. The disk drive assembly of claim 11, wherein the drive bracket comprises a stopper protrusion extending an edge of the securing opening, and a free end of the resilient tab resists the stopper protrusion.

13. The disk drive assembly of claim 11, wherein the drive bracket comprises a resisting portion extending from an edge of the securing opening; the resisting portion is adapted to press the resilient tab to enable the resilient tab to disengage from the securing opening.

14. The disk drive assembly of claim 10, wherein the drive bracket further comprises a second stopper portion extending from the second side panel, and the disk drive is located between the second stopper portion and the bottom panel.

15. The disk drive assembly of claim 10, wherein the bottom panel comprises a plurality of contacting tabs contacting the disk drive.

16. The disk drive assembly of claim 10, wherein the disk drive further comprises a second sidewall substantially parallel to the first sidewall; the drive bracket further comprises a resilient protrusion protruding from the second side panel; and the resilient protrusion resiliently resists the second sidewall.

17. The disk drive assembly of claim 10, wherein the drive bracket further comprises a resisting protrusion extending from the first side panel, the resisting protrusion resists the sidewall body, and the securing opening is located between the cutout and the resisting protrusion.
